(19) United States
(12) Patent Application Publication
(10) Pub. No.: US 2013/0019472 A1
(43) Pub. Date: Jan. 24, 2013

(54) METHOD OF MANUFACTURING A CAM CARRIER WITH CAM CARRIER BORE MACHINED APART FROM CYLINDER HEAD AND APPARATUS FOR SAME

(71) Applicant: Daniel K. Owusu, Grand Blanc, MI (US)

(72) Inventor: Daniel K. Owusu, Grand Blanc, MI (US)

(73) Assignee: GM GLOBAL TECHNOLOGY OPERATIONS LLC, Detroit, MI (US)

(21) Appl. No.: 13/186,874

(22) Filed: Jul. 20, 2011

(51) Int. Cl. B23P 11/00; B23Q 3/00

(52) U.S. Cl. 29/888.06; 29/281.1

(57) ABSTRACT

A method of manufacturing an engine includes providing an inventory of cylinder heads each having a first set of features and a first set of datums. The first set of features is spatially arranged relative to the first set of datums. A fixture that is apart from all of the cylinder heads is provided. The fixture has a second set of features spatially arranged relative to one another substantially identically as the first set of features are spatially arranged relative to one another. A cam carrier is secured to the fixture at the second set of features. A cam bore is machined in the cam carrier at a position determined relative to the second set of features and relative to a surface of the cam carrier that abuts the fixture.

### TECHNICAL FIELD

The invention relates to a method of manufacturing a cam carrier, and, more specifically to machining a cam bore in a cam carrier. An apparatus for carrying out the method is also provided.

### BACKGROUND

Cam carriers are sometimes used on engines in instances where packaging a valve train configuration between cam towers would otherwise be difficult because of limited space between the cam towers. For example, a continuously variable valve actuation system requires a cam carrier assembly which houses the intake camshaft and actuates a roller finger follower to output a continuously variable valve lift. In order to ensure that the camshaft is appropriately located relative to the cylinder head, the cam bore in the cam carrier is machined while the cam carrier is mounted to the cylinder head in the cylinder head subassembly line. The valve actuation system is assembled to the cam carrier and the valve actuator lash adjusted, also while the cam carrier is mounted to the cylinder head in the cylinder head subassembly line. The subassembly steps thus complicate the logistics of the assembly process of the cylinder head subassembly line.

### SUMMARY

A method of manufacturing a cam carrier is provided that allows a cam carrier bore to be machined with the cam carrier apart from (i.e., not connected to) the cylinder head to which it will be connected. The cam carrier with machined bore can then be connected to any cylinder head in an inventory of cylinder heads for which the cam carrier is designed. The cam carrier subassembly and valve train lash adjustment can be completed separately from the cylinder head production.

A method of manufacturing a cam carrier is provided. The cam carrier mounts to a cylinder head having a first set of features and a first set of datums. The first set of features is spatially arranged relative to the first set of datums. The method includes securing a cam carrier to a fixture at a second set of features of the fixture. The fixture is apart from the cylinder head and the features of the second set of features are spatially arranged relative to one another in a substantially identical manner as the first set of features are spatially arranged relative to one another. A cam bore is then machined in the cam carrier at a position determined relative to the second set of features and relative to a surface of the cam carrier that abuts the fixture. Because the features of the second set of features are spatially arranged substantially identically as the features of the first set of features, the cam bore is positioned relative to the first set of datums even though it is machined while on the fixture and separate from the cylinder head.

Optionally, the method may include assembling a valve train to the cam carrier as a cam carrier assembly after the cam bore is machined, and then securing the cam carrier assembly to the cylinder head. The valve train may also be calibrated prior to securing the cam carrier assembly to the cylinder head.

An apparatus for manufacturing a cam carrier includes the fixture described above.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in fragmentary cross-sectional view of an engine subassembly having a cam carrier mounted to a cylinder head and with the cylinder head mounted to an engine block;

FIG. 2 is a schematic plan view of the engine of FIG. 1;

FIG. 3 is a schematic illustration in fragmentary cross-sectional view of the cam carrier and cylinder head of FIG. 1;

FIG. 4 is a schematic perspective illustration in partial cross-sectional view of the cam carrier with a camshaft and valve train assembled to the cam carrier;

FIG. 5 is a schematic illustration in plan view of the cam carrier of FIG. 1;

FIG. 6 is a schematic illustration in cross-sectional view taken at lines 6-6 of FIG. 5 of the cam carrier, with the cam carrier assembled to a fixture;

FIG. 7 is a schematic illustration in plan view of the fixture of FIG. 6;

FIG. 8 is a flow diagram of a method of manufacturing the cam carrier of FIG. 1; and

FIG. 9 is a schematic side view illustration in partial fragmentary view of the engine of FIG. 1 showing first and second sets of datums.

### DETAILED DESCRIPTION

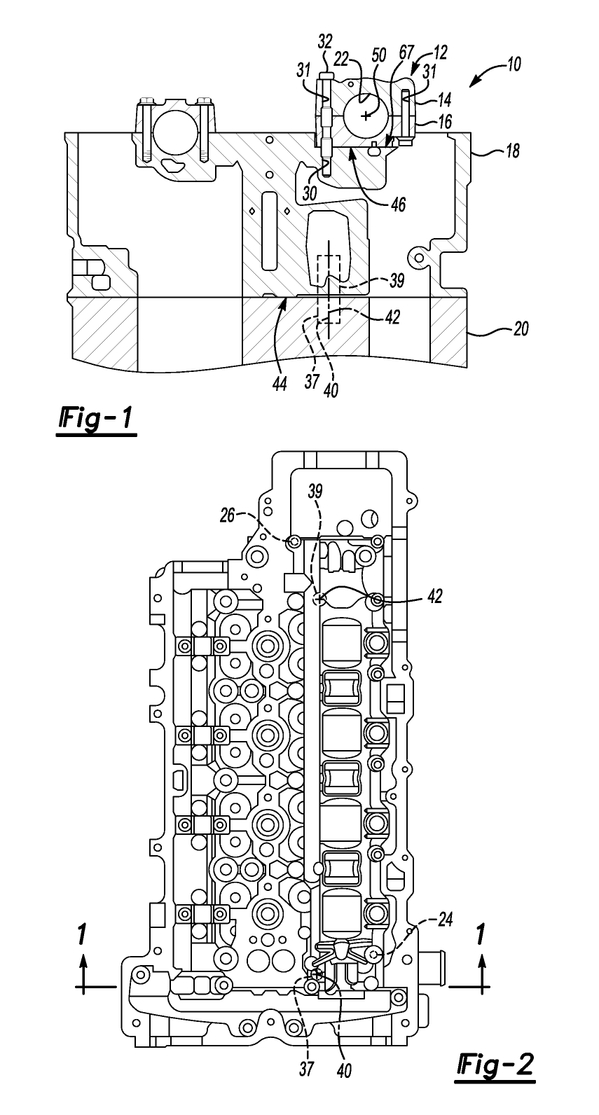

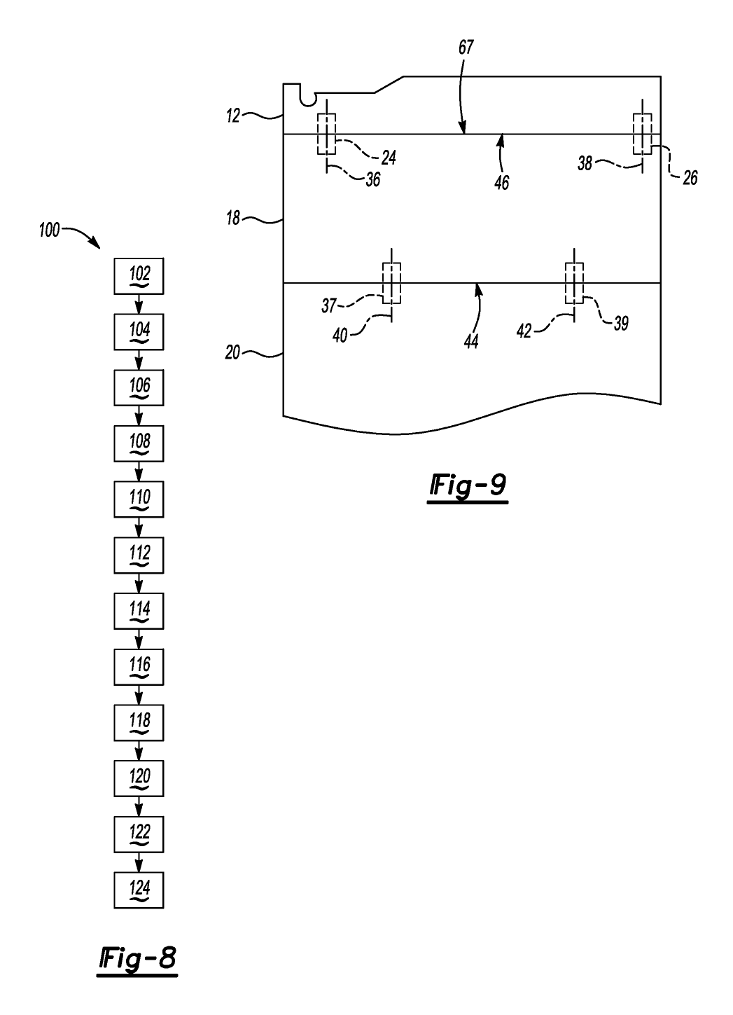

Referring to the drawings, wherein like reference numbers refer to like components throughout the several views, FIG. 1 shows an assembly 10 which is a portion of an engine. The assembly 10 includes a cam carrier 12 that includes an upper portion 14 and a lower portion 16. The cam carrier 12 is secured to a cylinder head 18. The cylinder head 18 is secured to an engine block 20. A bore 22 for a camshaft 23 (shown in FIG. 4) is machined in the cam carrier 12. A method of manufacturing 100 of FIG. 8 is provided that allows the bore 22 to be machined before the cam carrier 12 is secured to the cylinder head 18 while ensuring that the cam bore 22 will be correctly positioned relative to the engine block 20 and the cylinder head 18 even when the engine block 20 and cylinder head 18 are randomly chosen from an inventory of engine blocks of the same type as engine block 20 and an inventory of cylinder heads of the same type as cylinder head 18.

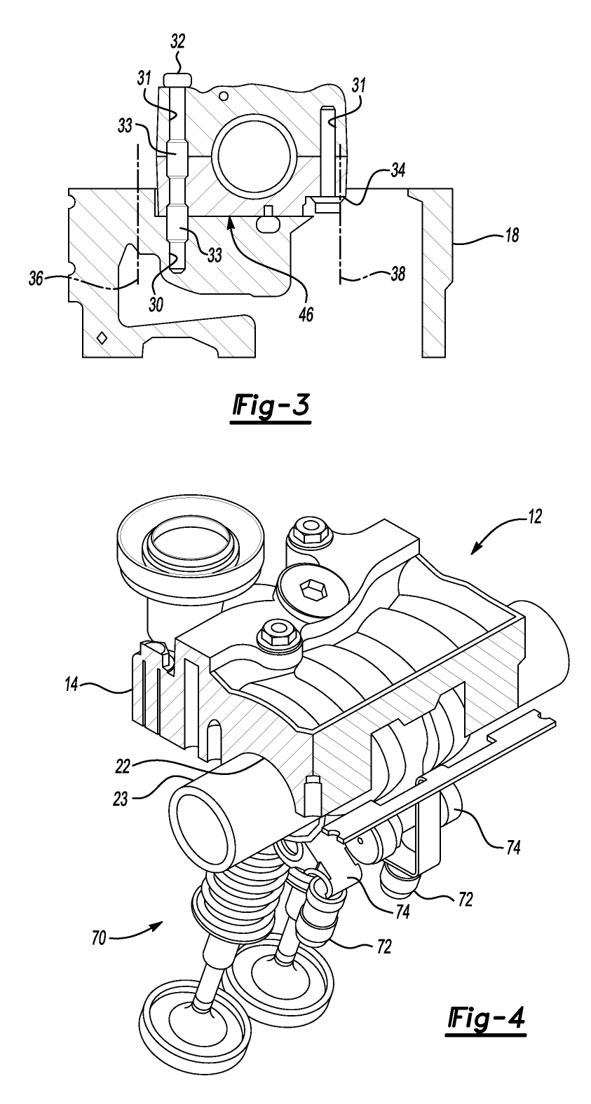

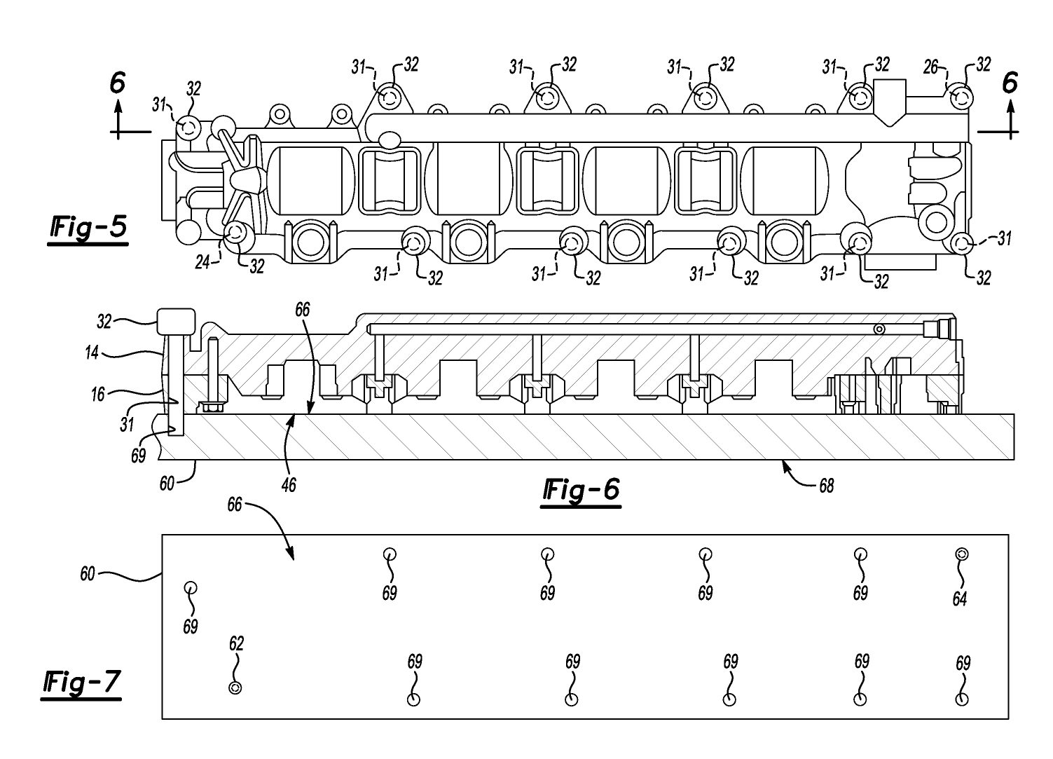

In order for the cam carrier 12, cylinder head 18 and engine block 20 to fit together in a functional manner, datums are established for various locating features of the components. For example, the cylinder head 18 has a first set of features that are positioned relative to a first set of datums that establish the position of the cylinder head 18 to the engine block 20. The first set of features are a first set of openings, dowel holes 24, 26, best shown in FIGS. 5 and 9, at which the cam carrier 12 is secured to the cylinder head 18. The dowel holes 24, 26 contain hollow dowels that allow fasteners 32 to pass through when the cam carrier 12 is positioned on the cylinder head 18. The hollow dowels are similar to hollow dowels 33 shown in FIG. 3. There are also many additional openings 30 (one shown in FIG. 3) in the cylinder head 18 at which the cam carrier 12 is secured to the cylinder head 18 with fasteners 32 that extend through hollow dowels 33 in the opening 30. The fasteners 32 extend through fastener openings 31 in the cam carrier 12, referred to as a third set of openings. The fastener openings 31 contain hollow dowels 33 connecting the portions 14, 16 of the cam carrier 12. The fasteners 32 extend through the hollow dowels. The fastener openings 31 are spaced relative to one another in the cam carrier 12 the same as the dowel holes 24, 26 and openings 30 are spaced relative to one another in the cylinder head 18. The dowel holes 24, 26 are spaced from one another in two directions, as can be seen from the relative spacing in both the vertical direction and the horizontal direction with respect to the plan view in FIG. 2. In FIGS. 1 and 3, one of the fastener openings 30 is shown, and a separate opening 31 only partially extends through the cam carrier 12 and has a different fastener 34 secured from below. The dowel holes 24, 26 are not visible in FIG. 1 or 3, but a centerline 36 of dowel hole 24 and a centerline 38 of dowel hole 26 are indicated relative to the cam carrier 22 and cylinder head 18 in FIG. 3. The dowel holes 24, 26 and centerlines 36, 38 are also shown with hidden lines in FIGS. 2, 3 and 9.

The cylinder head 18 is mounted to the engine block 20 by dowels positioned at dowel holes 37, 39 shown in phantom with centerlines 40, 42 indicated in FIGS. 1 and 2. The dowel holes 37, 39 are spaced relative to one another only in one direction in FIG. 2, as indicated by the alignment of the centerlines 40, 42. In FIG. 1, the dowel holes 37, 39 are not located at the cross-section taken, but it is apparent that the centerlines 40, 42 of the dowel holes align. The dowel holes 37, 39 and centerlines 40, 42 are also shown with hidden lines in FIG. 9. FIG. 1 also shows that the cylinder head 18 mounts to the engine block 20 at a mounting surface 44. The dowel holes 37, 39 and the mounting surface 44 establish a first set of datums from which the dowel holes 24, 26 at which the cam carrier 12 is mounted are spatially arranged. That is the tolerances of the center axes 36, 38 of the dowel holes 24, 26 at which the cam carrier 12 is positioned relative to the cylinder head 18 are predetermined tolerances from the centerlines 40, 42 of the dowel holes 37, 39 and from the mounting surface 44.

The cam carrier 12 also has a mounting surface 46 that abuts a first mounting surface 67 of the cylinder head 18 when the cam carrier 12 is mounted to the cylinder head 18. To maintain true positional requirements for the bore 22 in the cam carrier 12, the center axis 50 of the bore 22 is positioned by the boring machine relative to the dowel holes 37, 39 and mounting surface 44. However, for manufacturing efficiency, it is desired to machine the bore 22 without the cam carrier 12 being mounted to the cylinder head 18 and without the cam carrier 12 being necessarily tied to any specific cylinder head 18 in an inventory of like cylinder heads. Tracking specific cam carriers 12 with specific cylinder heads 18 is not necessary. In order to maintain the true position of the bore 22 relative to the first set of datums of the cylinder head 18 and yet machine the bore 22 without the cam carrier 12 being mounted to or associated with a specific cylinder head 18, the cam bore 22 is machined relative to the features of the cam carrier 12 that are positioned based on the first set of datums 24, 26, 44. This is accomplished by providing a fixture 60 that has a second set of features 62, 64 spaced relative to one another substantially identically as the first set of features 24, 26. The second set of features is fastener openings 62, 64 at which the cam carrier 22 can be mounted to the fixture 18. There are other fastener openings 69 in the fixture 18 as well. The other fastener openings 69 align with the other fastener openings 30 of the cylinder head 18. The fixture 60 also has a second mounting surface 66 that is substantially identical to the mounting surface 67 of the cylinder head 18 at which the cam carrier mounting surface 46 abuts the cylinder head 18. The second mounting surface 66 may have a predetermined dimensional tolerance with respect to a mounting surface 68 at which the fixture 60 mounts to a computer numeric control (CNC) machine.

After machining the bore 22, a valve train 70 may be assembled to the cam carrier 12, as shown in FIG. 4. The lower portion 16 of the cam carrier 12 is removed in FIG. 4 to better show the valve train 70. The valve train 70 may then be calibrated by testing and adjusting the hydraulic lash of the lash adjusters 72 for roller finger followers 74 of the valve train 70. The cam carrier assembly (i.e., the cam carrier 12 with the valve train 70, lash adjusters 72 and roller finger followers 74) may then be released from the fixture 60 and secured to any one of the cylinder heads 18 in an inventory of cylinder heads. There is no need to track a particular one of the cylinder heads 18 as the mate for the cam carrier 12. The cylinder head 18 may be on an assembly line when the cam carrier assembly is introduced and secured to the cylinder head 18. The cylinder head 18 may then be secured to any engine block 20 in an inventory of like engine blocks.

Because the bore 22 is positioned relative to the second set of features of the fixture 60, which in turn are positioned relative to one another just as the first set of features of the cylinder head 18 are positioned relative to one another, the cam carrier 12 may now be fit to any cylinder head 18 within the inventory of like cylinder heads.

Accordingly, with reference to the cam carrier 12, cylinder head 18 and engine block 20 shown and described with respect to FIGS. 1-7 and 9, FIG. 8 shows a flow diagram of a method 100 of manufacturing an engine 10. The method 100 includes block 102, providing an inventory of cylinder heads 18. Each cylinder head 18 is alike in that each includes a first set of features, dowel holes 24, 26 that are positioned relative to a first set of datums, dowel holes 37, 39 at which the cylinder head 18 mounts to an engine block 20, and a mounting surface 44 at which the cylinder head 18 mounts to the engine block 20.

The method 100 also includes block 104, providing a fixture 60 having a second set of features, fastener openings 62, 64, and a second mounting surface 66 at which the surface 46 of the cam carrier 12 will be mounted. The second set of features 62, 64 are spatially arranged relative to one another substantially identically as the first set of features 24, 26 are spatially arranged relative to one another;

The method further includes block 106, providing a cam carrier 12 having a third set of fastener openings 31 spaced relative to one another substantially identically to the relative spacing of the first set of features, dowel holes 24, 26 and openings 30, and the second sets of features in the fixture 60, fastener openings 62, 64. The cylinder head 18 has a mounting surface 67 for the cam carrier 12. The second mounting surface 66 of the fixture 60 is substantially identical to the mounting surface 67 of the cylinder head 18 for the cam carrier 12.

The method 100 includes block 108, securing the cam carrier 12 to the fixture 60 at the second mounting surface 66 by extending fasteners 32 through the second fastener openings 62, 64 and additional openings 69 in the fixture 60, and through the third set of fastener openings 31 in the cam carrier 12 with a mounting surface 46 of the cam carrier 12 abutting the fixture 60 at the second mounting surface 66.

Once the cam carrier 12 is secured to the fixture 60, the method 100 includes block 110, machining a cam bore 22 through the cam carrier while the cam carrier is secured to the fixture and is apart from all of the cylinder heads. As discussed above, the cam bore 22 is located in the cam carrier 12 relative to the second set of features, fastener openings 62, 64, as well as surface 66. The cam bore 22 is thereby being machined relative to the substantially identical first set of features, dowel holes 24, 26, and first mounting surface 67.

In block 112, the cam carrier 12 can then be released from from the fixture 60. A valve train 70, shown in FIG. 4, can then be assembled to the cam carrier 12 in block 114, and in block 116, the valve train 70 can be calibrated.

In block 118, the cam carrier 12 with the calibrated valve train 70 assembled thereto can then be secured to any one of the cylinder heads 18 in the inventory by extending the same or different fasteners 32 through the first and the third sets of fastener openings 31, 30, respectively, with the mounting surface 46 of the cam carrier 12 abutting the mounting surface 67 of the selected cylinder head 18.

The method 100 may include block 120, providing an inventory of engine blocks each substantially identical to engine block 20. In block 122, the cylinder head 18 with cam carrier 12 connected thereto can then be positioned on the engine block 20 at the first set of datums, the dowel holes 37, 39, with the first mounting surface 44 of the cylinder head 18 abutting the engine block 20. The cylinder head 18 can then be bolted to the engine block 20 in block 124.

While the best modes for carrying out the invention have been described in detail, those familiar with the art to which this invention relates will recognize various alternative designs and embodiments for practicing the invention within the scope of the appended claims.

1. A method of manufacturing an engine that includes a cylinder head having a first set of features and a first set of datums; wherein the first set of features are spatially arranged relative to a first set of datums; the method comprising:
securing a cam carrier to a fixture at a second set of features of the fixture; wherein the fixture is apart from the cylinder head and the second set of features are spatially arranged relative to one another substantially identically as the first set of features are spatially arranged relative to one another; and
machining a cam bore in the cam carrier at a position determined relative to the second set of features and relative to a surface of the cam carrier that abuts the fixture, the cam bore thus being positioned relative to the first set of datums with the cam carrier apart from the cylinder head.

2. The method of claim 1, further comprising:
assembling a valve train to the cam carrier after said machining; and
securing the cam carrier after said assembling to the cylinder head.

3. The method of claim 2, further comprising:
calibrating the valve train after said assembling the valve train to the cam carrier and prior to said securing the cam carrier to the cylinder head.

4. The method of claim 2, wherein the first set of datums include dowel holes at which the cylinder head is positioned on an engine block; and wherein the second set of features include additional dowel holes at which the cam carrier is positioned on the cylinder head.

5. The method of claim 2, further comprising:
providing an inventory of cylinder heads each having the first set of features and the first set of datums, wherein the cylinder head with the cam carrier assembled thereto is selected from the inventory of cylinder heads;
providing an inventory of engine blocks each having the first set of datums;
positioning the cylinder head with the cam carrier assembled thereto at the first set of datums of any one of the engine blocks; and
securing the cylinder head to said any one of the engine blocks.

6. The method of claim 2, wherein the cylinder head is on an assembly line when the cam carrier is secured thereto.

7. A method of manufacturing an engine comprising:
securing a cam carrier to a fixture;
machining a cam bore in the cam carrier while the cam carrier is secured to the fixture and is apart from a cylinder head;
wherein the cylinder head has a first set of features established relative to a first set of datums; wherein the first set of datums includes a first mounting surface at which the cylinder head mounts to an engine block; wherein the first set of features are first openings;
wherein the fixture has a second set of features and a second mounting surface; wherein the second set of features are second openings spatially arranged relative to one another substantially identically as the first set of features are spatially arranged relative to one another;
wherein the cam carrier has a third set of openings spaced relative to one another substantially identically to the relative spacing of the first and the second sets of features; wherein the cam carrier is secured at the second mounting surface of the fixture by extending fasteners through the second and the third sets of openings with a mounting surface of the cam carrier abutting the fixture at the second mounting surface;
wherein the cylinder head has a mounting surface for the cam carrier; wherein the second mounting surface of the fixture is substantially identical to the mounting surface of the cylinder head for the cam carrier;
wherein the cam bore is located in the cam carrier relative to the second set of features, the cam bore thereby being machined relative to the substantially identical first set of features and the first mounting surface;
releasing the cam carrier from the fixture; and
securing the cam carrier to the cylinder head by extending the same or different fasteners through the first and the third sets of openings with the mounting surface of the cam carrier abutting the cylinder head at the mounting surface of the cylinder head for the cam carrier.

8. The method of claim 7, further comprising:
assembling a valve train to the cam carrier after said machining and prior to said securing the cam carrier to the cylinder head.

9. The method of claim 8, further comprising:
calibrating the valve train after said assembling the valve train to the cam carrier and prior to said securing the cam carrier to the cylinder head.

10. The method of claim 7, wherein the first set of datums includes dowel holes at which the cylinder head is positioned on the engine block; and wherein the second set of features include additional dowel holes at which the cam carrier is positioned on the cylinder head.

11. The method of claim 7, further comprising:
providing an inventory of engine blocks; wherein the engine block is selected from the inventory of engine blocks; and
securing the cylinder head with the cam carrier assembled thereto at the first set of datums with the first mounting surface of the cylinder head abutting the engine block.

12. The method of claim 7, wherein the cylinder head is selected from an inventory of cylinder heads each having the first set of features and the first set of datums; and wherein the cylinder head is on an assembly line when the cam carrier is secured thereto.

13. An apparatus for manufacturing a cam carrier, wherein the cam carrier is configured to be secured to a cylinder head at a first mounting surface of the cylinder head and at a first set of features of the cylinder head that are spatially arranged relative to a first set of datums of the cylinder head, the apparatus comprising:
a fixture having a second mounting surface substantially identical to the first mounting surface and a second set of features spatially arranged relative to one another substantially identically as the first set of features are spatially arranged relative to one another, the cam carrier thereby being securable to the fixture at the second mounting surface and at the second set of features such that a cam bore machined in the cam carrier when the cam carrier is secured to the fixture is positioned relative to the first set of datums.
